(19) United States
(12) Patent Application Publication
(10) Pub. No.: US 2026/0187356 A1
(43) Pub. Date: Jul. 2, 2026

(54) SYSTEM AND METHOD FOR ARTIFICIAL INTELLIGENCE BASED WEB FORM COMPLETION

(71) Applicant: Enablon S.A.S., Courbevoie (FR)

(72) Inventors: Mirjana Mazuran, Paris (FR); Esther Minguez Collado, Velaux (FR); Timbus Calin-Lucian, Cluj-Napoca (RO); Bogdan-Andrei Donu, Iasi (RO); Benoit Rauturier, Copenhagen (DK); Tudor Ziman, Cluj-Napoca (RO); Shweta Pathak, Bois Colombes (FR); David Pedrosa Caldas da Rocha, Setubal (PT)

(21) Appl. No.: 19/004,668

(22) Filed: Dec. 30, 2024

(51) Int. Cl. G06F 40/174; G06F 3/023

(52) U.S. Cl. CPC G06F 40/174; G06F 3/0237

(57) ABSTRACT

A computer-implemented method comprises providing previous form data to a training and validation module, filtering the previous data to create a subset of training data meeting a validation threshold, for each of a plurality of web-based input forms training at least one artificial intelligence model relating to at least one field in at least one web-based input form using the subset of training data, deploying at least one model endpoint corresponding to a model based on the trained model and a template of the form, transmitting a web-based input form web page to a client device, wherein the web page is displayed on a user interface, wherein the web page includes an AI-based form field prediction text input portion used for the AI-based form field prediction and an interactive representation of the web-based input form separate and distinct from the free text input portion; receiving, from the client device, a first user input at the AI-based form field prediction text input portion of the web-based input form; requesting a plurality of suggested answers to the web-based input form based on the user input; selecting a respective model endpoint corresponding to the web-based input form; generating at least one predicted user input using the model endpoint and the first user input; modifying the interactive representation of the web-based input form to include the at least one predicted user input; transmitting the modified interactive representation of the web-based input form including the at least one predicted user input to the client device; receiving, from the client device, a second user input at certain fields of the modified interactive representation of the web-based input form relating to a user modification of the suggested answers; and storing the inputs at the fields of the completed web-based input form to the data platform.

### TECHNICAL FIELD

This application relates generally to systems and methods of automation using artificial intelligence, and more particularly, to systems and methods of using artificial intelligence to predict answers to fillable forms from free text.

### BACKGROUND

Data contributors (e.g., accountants, auditors, inspectors, etc.), whose job includes the duty to input data using web-based fillable forms, invest a substantial amount of time inputting data into digital forms. Accurate data entry is crucial as managers, executives, and other professionals rely on these data to understand companies' evolving realities, make decisions, and drive business. Data entry via web based fillable forms is a substantial expenditure of time across many domains, including legal, tax, accounting, environmental, health, safety and quality control.

Some companies claim that more than 25% of their data contains errors, and that 60% of erroneous data comes from human error by a data contributor or a entry worker. Costs associated with erroneous data could be up to $15 million annually.

Continuously monitoring and improving data quality is an important factor in having a strong data culture. Data management professionals encounter several challenges. First, manual data entry is tedious, time-consuming, and prone to errors. Second, reality changes and if data are not classified correctly, they become incomplete and obsolete. Third, insights are trustworthy only if the data is trustworthy.

Accordingly, it would be advantageous to achieve high data quality in data collection without substantially increasing the amount of time and resources expended entering the data.

### SUMMARY

A system of one or more computers can perform particular operations or actions by virtue of having software, firmware, hardware, or a combination of them installed on the system that in operation causes or cause the system to perform the actions. One or more computer programs can perform particular operations or actions by virtue of including instructions that, when executed by data processing apparatus, cause the apparatus to perform the actions. One general aspect includes a system for artificial intelligence (ai)-based form field prediction of web-based input forms. The system also includes a non-transitory memory. The system also includes a processor communicatively coupled to the non-transitory memory, where the processor reads a set of instructions to: provide previous form data from a data platform to a training and validation module, the training and validation module including a data preprocessing module, a training module, and a model deployment module; filter the previous data to create a subset of training data meeting a validation threshold using the data preprocessing module; for each of a plurality of web-based input forms, train, via the training module, at least one model relating to at least one field in at least one web-based input form using the subset of training data; deploy, via the model deployment module, at least one model endpoint corresponding to a respective model based on the model and a template of the web-based input form; transmit a web-based input form to a client device, where the web-based input form is displayed on a user interface at the client device, where the web-based input form includes an ai-based form field prediction text input portion used for ai-based form field prediction and an interactive representation of the web-based input form separate and distinct from the ai-based form field prediction text input portion; receive, from the client device, a first user input at the ai-based form field prediction text input portion of the web-based input form; transmit the first user input provided at the ai-based form field prediction text input portion of the web-based input form to an inference module to obtain a plurality of suggested answers to the web-based input form based on the user input; select a respective model endpoint corresponding to the web-based input form; generate at least one predicted user input corresponding to at least one form field of the web-based input form using the at least one model endpoint and the first user input provided at the ai-based form field prediction text input portion of the web-based input form; modify the interactive representation of the web-based input form to include the at least one predicted user input; transmit the modified interactive representation of the web-based input form including the at least one predicted user input to the client device; receive, from the client device, a second user input at certain fields of the modified interactive representation of the web-based input form relating to a user modification of the suggested answers; and store the inputs at the fields of the web-based input form to the data platform. Other embodiments of this aspect include corresponding computer systems, apparatus, and computer programs recorded on one or more computer storage devices, that each perform the actions of the methods.

Implementations may include one or more of the following features. The system where generating at least one predicted user input corresponding to at least one form field of the web-based input form includes: detecting personal information within the first user input, and generating at least one predicted user input corresponding to at least one form field of the web-based input form using the detected personal information. The processor reads instructions to: translate the first user input from a first natural language to a second natural language, where the first natural language is a different natural language from the second natural language, and where the second natural language is the same as a reference natural language that is used in the previous data provided to the training and validation module to train the artificial intelligence model. The processor reads instructions to: detect an acronym in the first user input, and to replace the acronym with an expanded form of the acronym prior to parsing the first user input with the at least one model endpoint. The processor reads instructions to: calculate a reliability probability for one of the plurality of suggested answers, and to refrain from modifying the interactive representation of the web-based input form to include a predicted user input if the probability is below a reliability threshold. Selecting a respective model endpoint corresponding to the web-based input form includes deploying at least two model endpoints based on at least two trained artificial intelligence models corresponding to one of the web-based input forms, and selecting one of the respective model endpoints having the highest reliability probability. One of the at least two artificial intelligence models is a machine learning model, and where one of the at least two artificial intelligence models is a deep learning model. Implementations of the described techniques may include hardware, a method or process, or computer software on a computer-accessible medium.

One general aspect includes a computer-implemented method. The computer-implemented method also includes providing previous form data from a data platform to a training and validation module, the training and validation module including a data preprocessing module, a training module, and a model deployment module. The method also includes filtering the previous data to create a subset of training data meeting a validation threshold using the data preprocessing module. The method also includes for each of a plurality of web-based input forms training, via the training module, at least one artificial intelligence model relating to at least one field in at least one web-based input form using the subset of training data. The method also includes deploying, via the model deployment module, at least one model endpoint corresponding to a respective artificial intelligence model based on the trained artificial intelligence model and a template of the web-based input form. The method also includes transmitting a web-based input form web page to a client device, where the web-based input form web page is displayed on a user interface at the client device, where the web-based input form web page includes an ai-based form field prediction text input portion used for the ai-based form field prediction and an interactive representation of the web-based input form separate and distinct from the ai-based form field prediction text input portion. The method also includes receiving, from the client device, a first user input at the ai-based form field prediction text input portion of the web-based input form. The method also includes transmitting the first user input provided at the ai-based form field prediction text input portion of the web-based input form to an inference module to request obtain a plurality of suggested answers to the web-based input form based on the user input. The method also includes selecting a respective model endpoint corresponding to the web-based input form. The method also includes generating at least one predicted user input corresponding to at least one form field of the web-based input form using the at least one model endpoint and the first user input provided at the ai-based form field prediction text input portion of the web-based input form. The method also includes modifying the interactive representation of the web-based input form to include the at least one predicted user input. The method also includes transmitting the modified interactive representation of the web-based input form including the at least one predicted user input to the client device. The method also includes receiving, from the client device, a second user input at certain fields of the modified interactive representation of the web-based input form relating to a user modification of the suggested answers. The method also includes storing the inputs at the fields of the web-based input form to the data platform. Other embodiments of this aspect include corresponding computer systems, apparatus, and computer programs recorded on one or more computer storage devices, that each perform the actions of the methods.

Implementations may include one or more of the following features. The method where generating at least one predicted user input corresponding to at least one form field of the web-based input form includes: detecting personal information within the first user input, and generating at least one predicted user input corresponding to at least one form field of the web-based input form using the detected personal information. The first natural language is a different natural language from the second natural language, and where the second natural language is the same as a reference natural language that is used in the previous data provided to the training and validation module to train the artificial intelligence model. The method may include detecting an acronym in the first user input, and to replace the acronym with an expanded form of the acronym prior to parsing the first user input with the at least one model endpoint. The method may include calculating a reliability probability for one of the plurality of suggested answers, and to refrain from modifying the interactive representation of the web-based input form to include a predicted user input if the probability is below a reliability threshold. Selecting a respective model endpoint corresponding to the web-based input form includes: deploying at least two model endpoints based on at least two trained artificial intelligence models corresponding to one of the web-based input forms, and selecting one of the respective model endpoints having the highest reliability probability. One of the at least two artificial intelligence models is a machine learning model, and where one of the at least two artificial intelligence models is a deep learning model. Implementations of the described techniques may include hardware, a method or process, or computer software on a computer-accessible medium.

One general aspect includes a non-transitory computer readable medium having instructions stored thereon. The non-transitory computer readable medium also includes providing previous form data from a data platform to a training and validation module, the training and validation module including a data preprocessing module, a training module, and a model deployment module; filtering the previous data to create a subset of training data meeting a validation threshold using the data preprocessing module; for each of a plurality of web-based input forms training, via the training module, at least one artificial intelligence model relating to at least one field in at least one web-based input form using the subset of training data; deploying, via the model deployment module, at least one model endpoint corresponding to a respective artificial intelligence model based on the trained artificial intelligence model and a template of the web-based input form; transmitting a web-based input form web page to a client device, where the web-based input form web page is displayed on a user interface at the client device, where the web-based input form web page includes an ai-based form field prediction text input portion used for the ai-based form field prediction and an interactive representation of the web-based input form separate and distinct from the free text AI-based form field prediction input portion; receiving, from the client device, a first user input at the ai-based form field prediction text input portion of the web-based input form; transmitting the first user input provided at the ai-based form field prediction text input portion of the web-based input form to an inference module to request a plurality of suggested answers to the web-based input form based on the user input; selecting a respective model endpoint corresponding to the web-based input form; generating at least one predicted user input corresponding to at least one form field of the web-based input form using the at least one model endpoint and the first user input provided at the ai-based form field prediction text input portion of the web-based input form; modifying the interactive representation of the web-based input form to include the at least one predicted user input; transmitting the modified interactive representation of the web-based input form including the at least one predicted user input to the client device; receiving, from the client device, a second user input at certain fields of the modified interactive representation of the web-based input form relating to a user modification of the suggested answers; and storing the inputs at the fields of the web-based input form to the data platform. Other embodiments of this aspect include corresponding computer systems, apparatus, and computer programs recorded on one or more computer storage devices, that each perform the actions of the methods.

Implementations may include one or more of the following features. The medium where generating at least one predicted user input corresponding to at least one form field of the web-based input form includes: detecting personal information within the first user input, and generating at least one predicted user input corresponding to at least one form field of the web-based input form using the detected personal information. The instructions, when executed by at least one processor, cause at least one device to further perform operations may include: translating the first user input from a first natural language to a second natural language, where the first natural language is a different natural language from the second natural language, and where the second natural language is the same as a reference natural language that is used in the previous data provided to the training and validation module to train the artificial intelligence model. The instructions, when executed by at least one processor, cause at least one device to further perform operations may include: detecting an acronym in the first user input, and to replace the acronym with an expanded form of the acronym prior to parsing the first user input with the at least one model endpoint. The instructions, when executed by at least one processor, cause at least one device to further perform operations may include: calculating a reliability probability for one of the plurality of suggested answers, and to refrain from modifying the interactive representation of the web-based input form to include a predicted user input if the probability is below a reliability threshold. Selecting a respective model endpoint corresponding to the web-based input form includes: deploying at least two model endpoints based on at least two trained artificial intelligence models corresponding to one of the web-based input forms, and selecting one of the respective model endpoints having the highest reliability probability. One of the at least two artificial intelligence models is a machine learning model, and where one of the at least two artificial intelligence models is a deep learning model. Implementations of the described techniques may include hardware, a method or process, or computer software on a computer-accessible medium.

### BRIEF DESCRIPTION OF THE DRAWINGS

The features and advantages of the present disclosure will be more fully disclosed in, or rendered obvious by the following detailed description of the preferred embodiments, which are to be considered together with the accompanying drawings wherein like numbers refer to like parts and further wherein:

FIG. 1 illustrates a network environment that provides artificial intelligence aided data entry form filling, in accordance with some embodiments;

FIG. 2 illustrates a computer system that implements one or more processes, in accordance with some embodiments;

FIG. 3 illustrates an example of a user interface in accordance with a state of the art in the absence of the present disclosure;

FIG. 4 illustrates an example of a user interface in accordance with some embodiments;

FIG. 5 is a process flow, in accordance with some embodiments;

FIG. 6A illustrates an artificial neural network, in accordance with some embodiments;

FIG. 6B illustrates a tree-based artificial neural network, in accordance with some embodiments;

FIG. 6C illustrates a deep neural network (DNN), in accordance with some embodiments;

FIG. 7A is a flowchart illustrating a training method for generating a trained machine learning model, in accordance with some embodiments; and

FIG. 7B is a process flow illustrating various steps of the training method of FIG. 7A, in accordance with some embodiments.

FIGS. 8A-8B are flowcharts illustrating a method with various steps, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for artificial intelligence aided data entry form filling. In some embodiments, systems, and methods for artificial intelligence aided data entry form filling includes the use of one or more trained machine learning and/or deep learning models.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate suggested web-based form answers, are disclosed. A neural network trained to generate suggested web-based form answers may be referred to as a trained machine learning and/or deep learning model. A trained machine learning and/or deep learning model may receive a set of input data, e.g. a free text narrative, and suggest answers to specific questions asked by one or more digital forms.

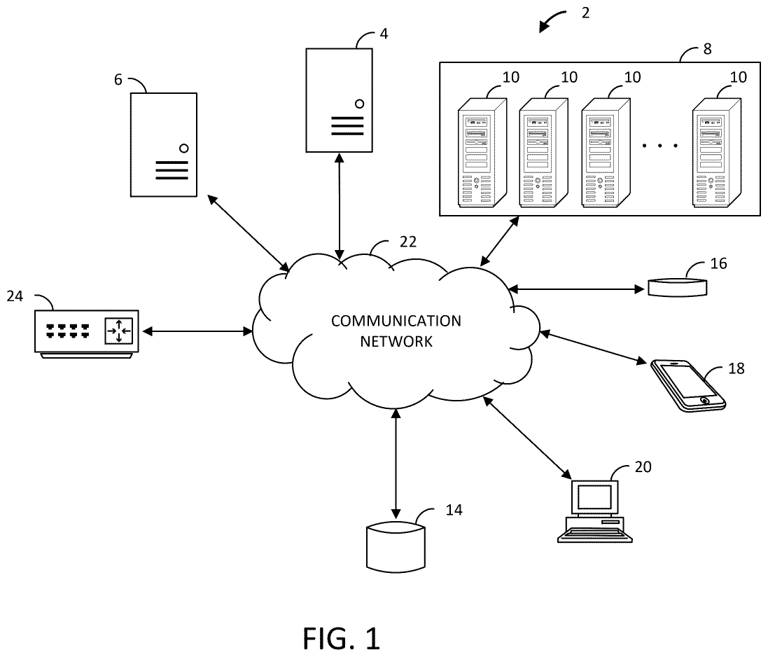

FIG. 1 illustrates a network environment 2 provides artificial intelligence aided data entry form filling, in accordance with some embodiments. The network environment 2 includes a plurality of devices or systems that communicate over one or more network channels, illustrated as a network cloud 22. For example, in various embodiments, the network environment 2 may include, but is not limited to, an artificial intelligence aided data entry form filling computing device 4, a web server 6, a cloud-based engine 8 including one or more processing devices 10, a database 14, and/or one or more user computing devices 16, 18, 20 operatively coupled over the network 22. The artificial intelligence aided data entry form filling computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the artificial intelligence aided data entry form filling computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the artificial intelligence aided data entry form filling computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as a data entry network environment. In some embodiments, the artificial intelligence aided data entry form filling computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the artificial intelligence aided data entry form filling computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the artificial intelligence aided data entry form filling computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as a data entry and/or web-based form completion website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. In some embodiments, the web server 6 transmits user interaction data identifying interactions between the user and the website to the artificial intelligence aided data entry form filling computing device 4.

In some embodiments, the artificial intelligence aided data entry form filling computing device 4 may execute one or more models, processes, or algorithms, such as a machine learning model, deep learning model, statistical model, etc., to artificial intelligence aided data entry form filler. The artificial intelligence aided data entry form filling computing device 4 may transmit suggested form answers to the web server 6 over the communication network 22, and the web server 6 may display interface elements associated with data entry on the website to the user.

The artificial intelligence aided data entry form filling computing device 4 is further operable to communicate with the database 14 over the communication network 22. For example, the artificial intelligence aided data entry form filling computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the artificial intelligence aided data entry form filler computing device 4, in some embodiments, the database 14 may be a local storage device, such as a hard drive, a non-volatile memory, or a USB stick. The artificial intelligence aided data entry form filler computing device 4 may store interaction data received from the web server 6 in the database 14.

In some embodiments, the artificial intelligence aided data entry form filling computing device 4 generates training data for a plurality of models (e.g., machine learning models, deep learning models, statistical models, algorithms, etc.) based on historical user session data, search data, previous finalized filled digital form data, etc. The artificial intelligence aided data entry form filling computing device 4 and/or one or more of the processing devices 10 may train one or more models based on corresponding training data. The artificial intelligence aided data entry form filling computing device 4 may store the models in a database, such as in the database 14 (e.g., a cloud storage database).

The models, when executed by the artificial intelligence aided data entry form filling computing device 4, allow the artificial intelligence aided data entry form filling computing device 4 to display suggested answers for fillable forms based on free text user input. For example, the artificial intelligence aided data entry form filling computing device 4 may obtain one or more models from the database 14. The artificial intelligence aided data entry form filling computing device 4 may then receive, in real-time from the web server 6, free text user input. In response to receiving free text user input, the artificial intelligence aided data entry form filling computing device 4 may execute one or more models to display suggested answers to the questions or other specific input areas of the form.

In some embodiments, the artificial intelligence aided data entry form filling computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, artificial intelligence aided data entry form filling computing device 4 may generate a draft of a filled in form, e.g. for editing and confirmation of the accuracy of the suggested answers based on the free text user input.

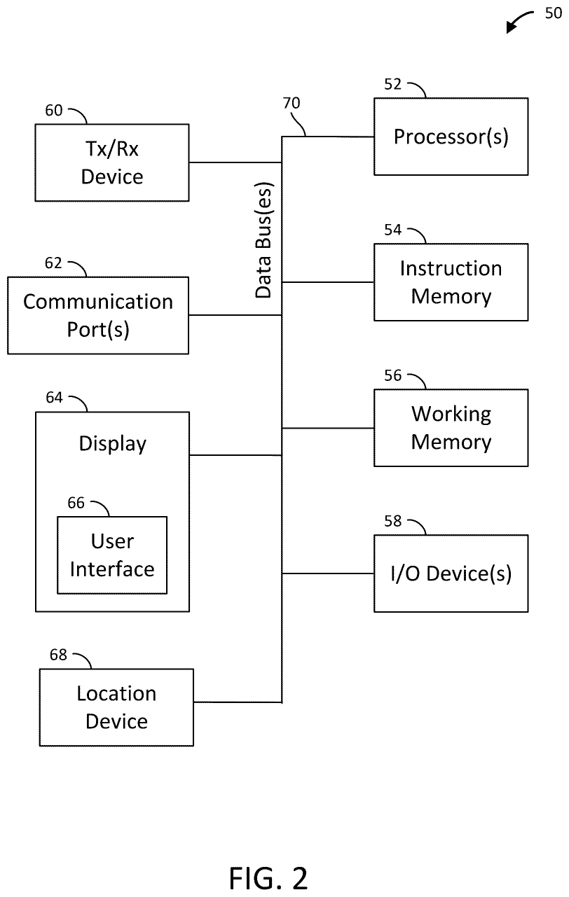

FIG. 2 illustrates a block diagram of a computing device 50, in accordance with some embodiments. In some embodiments, each of the artificial intelligence aided data entry form filling computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication port(s) 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may perform a certain function or operation by executing code, stored on the instruction memory 54, embodying the function or operation. For example, the one or more processors 52 may execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit operates as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for artificial intelligence aided data entry form filling, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processors 52.

The input/output devices 58 may include any suitable device that allows for data input or output. For example, the input/output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 allows communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with one or more digital fillable forms. For example, the user interface 66 may be a user interface for an application of a network environment operator that allows a user to view and interact with the operator's website. In some embodiments, a user may interact with the user interface 66 by engaging the input/output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device that receives position data identifying a latitude and longitude from one or more satellites of a GPS constellation. As another example, in some embodiments, the location device 68 is a cellular device that receives location data from one or more localized cellular towers. Based on the position data, the computing device 50 may determine a local geographical area (e.g., town, city, state, etc.) of its position.

In some embodiments, the computing device 50 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

Th present disclosure improves data quality in data collection via electronic fillable forms. The present disclosure may use machine learning, deep learning and/or other artificial intelligence models to automatically classify free text into suggested answers to fields on a form. Assigned classes may be used to suggest answers to questions on input forms. While users focus on inputting free text (e.g., description of an event), the artificial intelligence models may be used to proactively suggest or complete answers to specific input fields such as questions (e.g., was anyone hurt?, was there environmental damage, etc.) and categorize the text. In some embodiments, one or more information elements may be identified directly from the free text. For example, dates (e.g., today, yesterday, specific day, etc.) or impacts (e.g., head injury, bruise, heart attack, etc.) may be extracted or determined from free form text. The system may allow users to confirm or correct the suggested answers, providing feedback to the model or models to learn and improve.

Using artificial intelligence models to create suggested answers to forms and automatically adding generated answers to the forms to allow the user to edit the pre-filled forms improves data quality by decreasing errors, improving consistency, limiting the propagation of errors further in the data lifecycle, and by suggesting values, which enhances data completeness and user experience.

Prior to the present disclosure, data entry workers performed manual data entry using data entry forms, which are increasingly digital, e.g., internet-based. Some forms can contain dozens of fields to fill in, and some single forms may require 20 minutes to complete. Depending on the number of forms to be filled in, some data providers may spend 3 hours a day manually entering data into digital forms. Moreover, the quality of the data entered can be low, with optional fields left empty and data being misclassified.

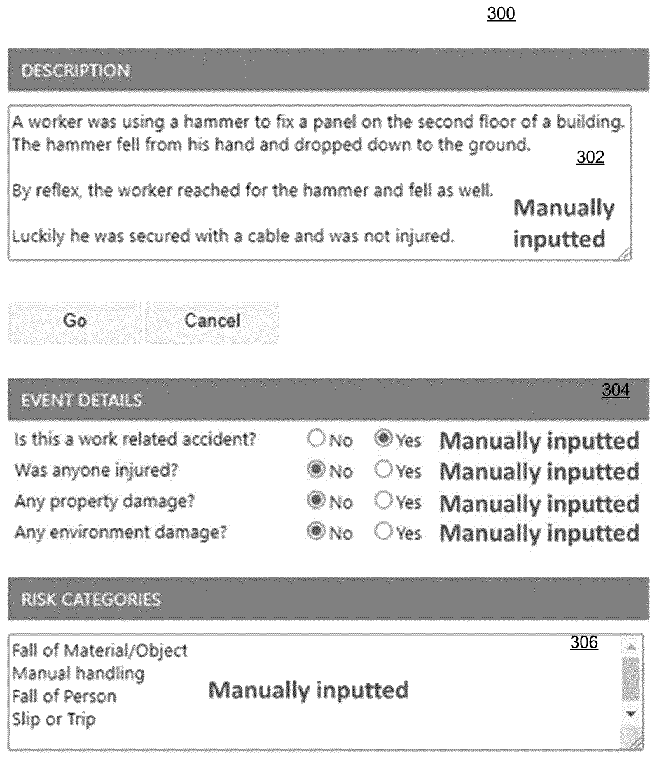

Turning now to FIG. 3, a user interface for a fillable digital form 300, in accordance with the state of the art in the absence of the present disclosure, is shown. In FIG. 3, a free text box 302 contains a description of an event for which data may be input for further handling by a business or other entity. In some digital forms, such a free text box may not be present. In others, it may be present but perform no function other than to be read in conjunction with other entries to the form. Question and answer choices 304 are also shown. In digital forms in the absence of the present disclosure, question and answer choices 304 are filled manually, e.g. by a data entry worker. Multiple object choice boxes 306 may also be present in a digital form. As with question and answer choices 304, multiple object choice boxes 306 are filled manually, e.g. by a data entry worker. Other user interface elements for the filling of digital forms may also be present, and all must be filled manually.

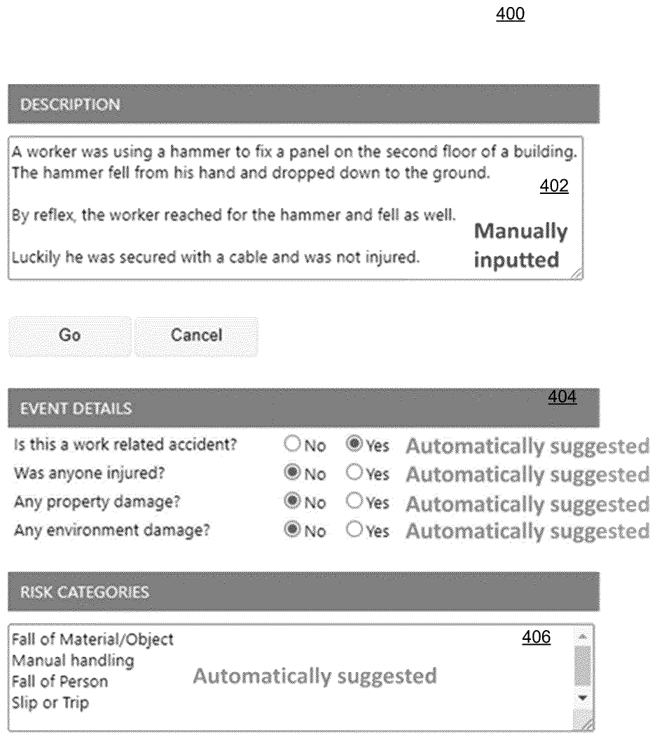

Turning now to FIG. 4, where a user interface for fillable digital form 400, in accordance with an embodiment of the present disclosure, is shown. In FIG. 4, a free text box 402 is present, similar to the free text box 302 of FIG. 3. Question and answer choices 404 and multiple object choice boxes 406 are also present, analogous to those user interface elements as shown in FIG. 3. However, as shown in FIG. 4 and as described in further detail below, the answers to question and answer choices 404 and object choice boxes 406 are automatically suggested, based on analysis of the text entered in free text box 402. As described in more detail below, the free text input by the data entry worker into free text box 402 is analyzed by one or more artificial intelligence models that relate to the form 400, and, in some embodiments, are trained on previous answers to form 400. The artificial intelligence models then predict the answers to the questions asked in question and answer choices 404 and in object choice boxes 406, based on the free text input in free text box 402. The predicted answers are then propagated back to form 400, where they are filled in as answers in the user interface as suggested answers. Then, instead of answering all of the questions, the data entry worker instead is tasked only with confirming that the suggested answers are correct.

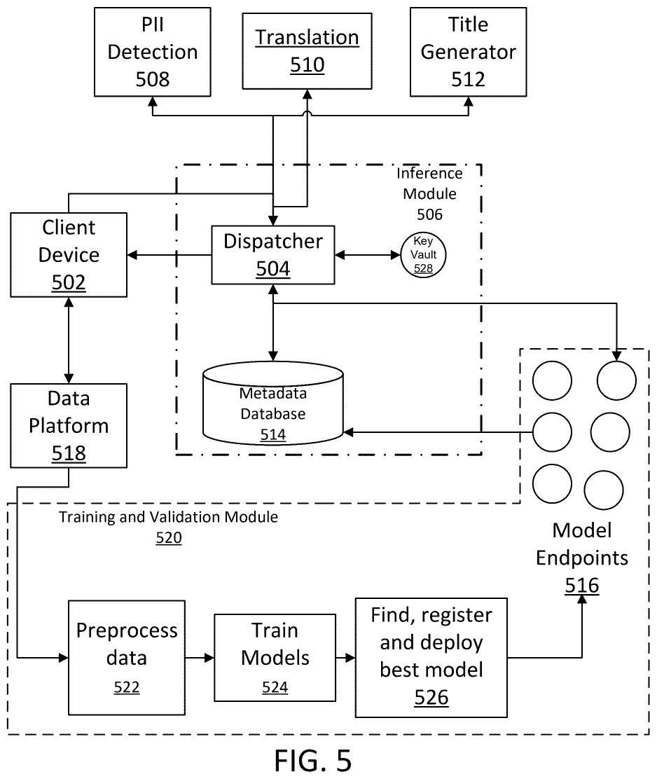

Turning now to FIG. 5, a data and process flow, in accordance some embodiments, is shown. On client device 502, a user interface for filling out a digital form, such as the user interface FIG. 4, is presented so that a user, e.g. a data entry worker, may interact with the user interface to fill in the digital form, e.g. digital form 400, e.g. to add a new event to a database of events, the events being documented by the data captured on form 400.

As shown in FIG. 5, user input may be received at the client device, e.g. the user may enter free text in free text box 402. In this example, the text reads: “A worker was using a hammer to fix a panel on the second floor of a building. The hammer fell from his hand and dropped down to the ground. By reflex, the worker reached for the hammer and fell as well. Luckily he was secured with a cable and was not injured.” From the free text, as explained in more detail below, artificial intelligence models suggest answers to questions shown in question and answer choices 404 and object choice boxes 406. The free text user input may be sent to dispatcher 504, which may be a part of inference module 506.

In some embodiments, dispatcher 504 may send the free text input to other modules, to modify the data, e.g., in a manner known to improve the results of AI models, or for other reasons. The free text input may be sent as a data structure format, such as a JavaScript Object Notation (“JSON”). By having the data in a structured format, AI models may more easily process the data to generate a result. In some embodiments, dispatcher 504 may send the free text data to PII detection module 508, which may detect personally identifying information (“PII”) in the free text input, and may edit the free text input to remove the personally identifying information, either for security reasons and/or to improve analysis of the free text input by AI models.

In some embodiments, dispatcher 504 may send the free text input to translation module 510. In some instances, an artificial intelligence model may be modeled in a reference natural language, such as English, while free text input may be in a different natural language, such as Spanish. In some embodiments, translating the free text input from Spanish to English improves suggested form responses. In some embodiments, a title, e.g. of or for the data item or record that form 400 is reporting, may be helpful, either in artificial intelligence processing or in accessing or locating the data later.

In some embodiments, the free text input may be sent to title generator 512 to generate a title of the record. In various embodiments, the system 500 may utilize none, some, or all of PII detection module 508, translation module 510, and/or title generator 512. PII detection module 508, translation module 510, and/or title generator 512 may be used in any order relative to each other, and may also be used in parallel or in serial with one another. After PII detection module 508, translation module 510, and/or title generator 512 have modified the free text input, the modified free text input may then be sent back to dispatcher 504.

Dispatcher 504 may then communicate with metadata database 514 to determine the appropriate AI model to use for further processing. Metadata database 514 may include metadata information about available artificial intelligence models that may be available to analyze the modified free text input, for the purposes of filling out form 400. In some embodiments, there may be multiple AI models that can be deployed relating to a corresponding form 400, or to individual fields that are part of a particular form 400. The accuracy of each model may be tracked in metadata, which may be reflected in a score such as an F1 score. The metadata in metadata database 514 may include information about which models have provided more accurate results in previous invocations of the particular form 400. In some embodiments, F1 scores or other accuracy related metadata may be used in selecting a model to evaluate the modified free text input. Other metadata relating to the AI models may also be stored in metadata database, such as reference URLs to the models themselves.

Dispatcher 504 may then use the metadata in metadata database 514 to choose one of model endpoints 516. Model endpoints 516 represent the different available models to predict form information. In some embodiments, model endpoints are virtual machines that implement the models. In some embodiments, the system has a plurality of model endpoints, which may correspond to different digital fillable forms. In a system that handles data for distinct entities, there may be different model endpoints 516 for each different entity. This may be for several reasons, one of which is that data from one entity may not be permitted, e.g. for security or confidentiality reasons, to be used in a model for a different, e.g. unrelated, entity. Accordingly, there may be different models for similar forms trained using different data. Training the models is described herein below. In some embodiments, a model endpoint 516 may, e.g. periodically, transmit an update regarding itself, to metadata database 514, so that dispatcher 504 has the most up to date information when using metadata database 514 to select a model endpoint 516. Once the model endpoint 516 is chosen, it may then receive the modified text input from dispatcher 504.

The chosen model endpoint 516 may apply its AI model to the modified text input, to generate one or more suggested answers to the non-free-text fields of form 400. In the example shown in FIG. 4, the model endpoint 516 may predict that the incident described in the modified text input is a work related accident, that nobody was injured, that there was no property damage, and that there was no environmental damage. Model endpoint 516 may also predict that none of the risk categories in object choice boxes 406 apply. The predicted answers may then be transmitted from the chosen model endpoint 516 to dispatcher 504.

The interactive representation of form 400, on the user interface of FIG. 4, may then be modified to include the predicted answers, presented to the user as suggested answers. The modified interactive representation of the digital form 400, with suggested answers, may then be displayed on client device 502. Once the suggested answers are presented, in some embodiments the user is given the option of changing the suggested answers, e.g. if any of them are incorrect in the judgment of the user. Once the form is finalized, the user may so indicate, e.g. by interacting with a user interface element such as a “submit” button.

Once the data is validated by the user as being final, it may be sent to data platform 518, which may store the data for various uses including uses related and unrelated to the present disclosure. One such use may be for training the models implemented at model endpoints 516. For training, data platform 518 may send the completed form data to training and validation module 520. This may occur at predetermined time intervals, e.g. daily or weekly. In training and validation module 520, data may be filtered to ensure that only data that is validated by a user as correct and final may be used to train the AI models. Data may also be pre-processed by one or more preprocessing modules 522, so that it is optimized for use as training data. For instance, free text user input in the form data may include acronyms that are in every day usage in the business of the data entry worker, but may be unknown to a generalized system such as an artificial intelligence model. Accordingly, in some instances the text input, which may have been previously modified by PII detection module 508, translation module 510, and/or title generator 512, may be further processed by preprocessing module 522 to expand acronyms to the full words, for easier use in training AI models. After data is pre-processed, it may be used by training module 524, which may use it to train the models as discussed herein. Training module may, for example receive and use information regarding which of the suggested answers were accepted by the user, and which suggested answers were changed by the user. This information, combined with the modified free text input, may assist in training the model to more accurately predict and suggest answers for that field when similar free text user input is received in the future. Once the models' training is updated by training module 524, the models are evaluated for quality, and the best ones may then be deployed as model endpoints 516 for future use, as discussed above.

In some embodiments, machine learning models using small or large language models may be used. In other embodiments, deep learning models may be used. Small language models, large language models, and deep learning models may, in some embodiments, all be deployed for the same form for the same entity, and may be evaluated for accuracy, e.g. from time to time. For each time free text user input is submitted for a form, the model that is testing as the most accurate, at that time, may then be selected for use.

It will be appreciated that determinations as disclosed herein, particularly on large datasets intended to be used with the disclosed embodiments/to generate trained models used in the disclosed embodiments, is only possible with the aid of computer-assisted machine-learning algorithms and techniques, such as machine learning and/or deep learning. In some embodiments, machine learning processes including machine learning and/or deep learning are used to perform operations that cannot practically be performed by a human, either mentally or with assistance, such as artificial intelligence aided data entry form filler. It will be appreciated that a variety of machine learning techniques can be used alone or in combination to generate form field answers from free text.

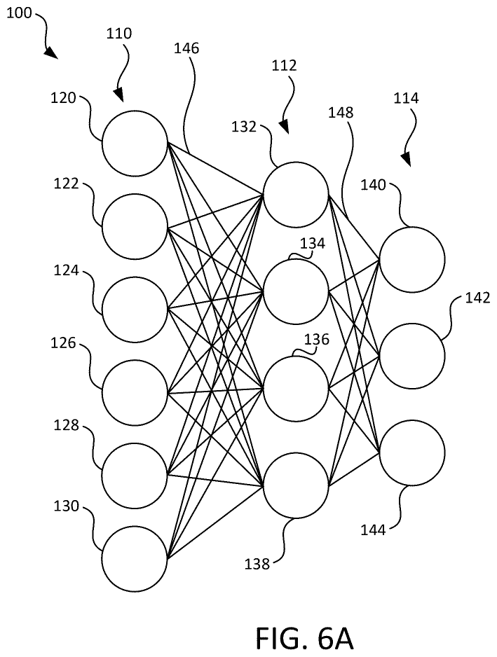

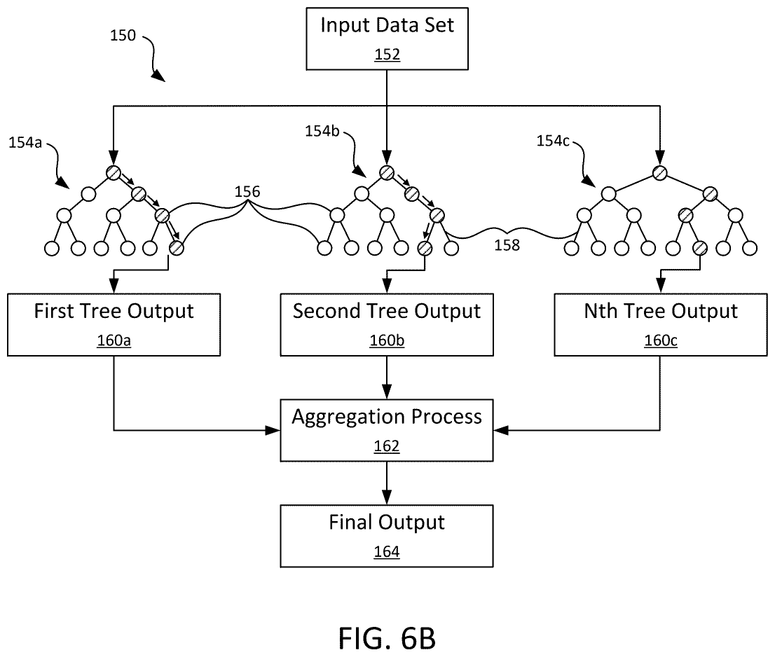

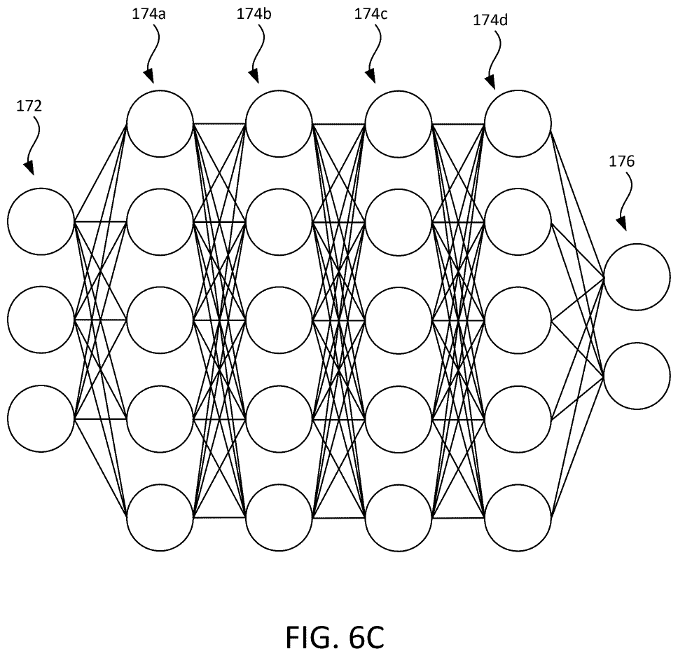

FIG. 6A illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( n , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

FIG. 6B illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

FIG. 6C illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 models complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers that each execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)} where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + ⋯ + {f}_{K} ( {x}_{K} )$$

where β is an offset and each ƒᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( lo gx )} {e}^{{\sum }_{i} {f}_{i}^{d} ( {d}_{i} )}$$

where d represents one or more features of the independent variable x.

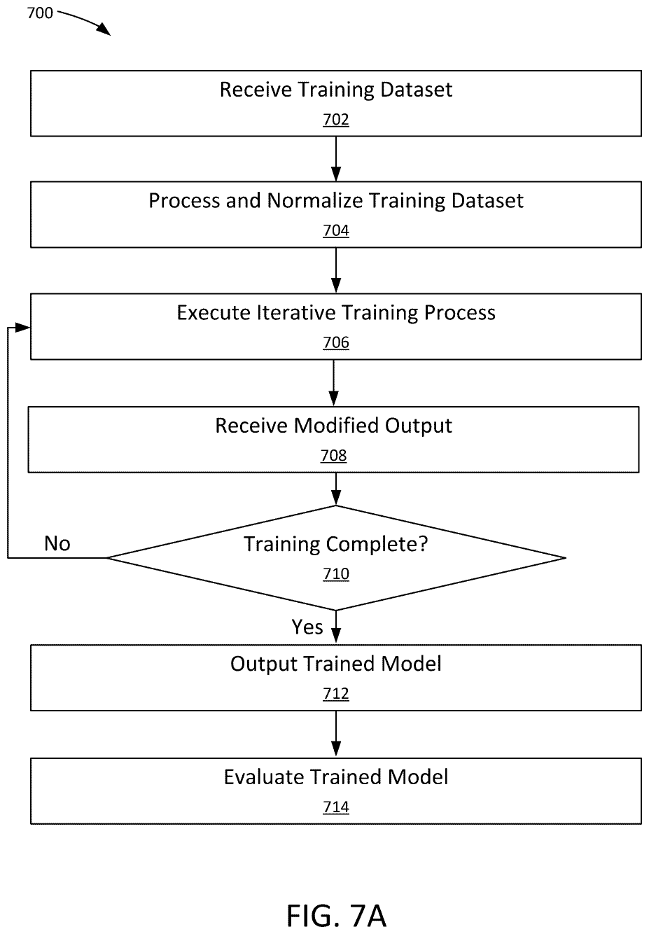

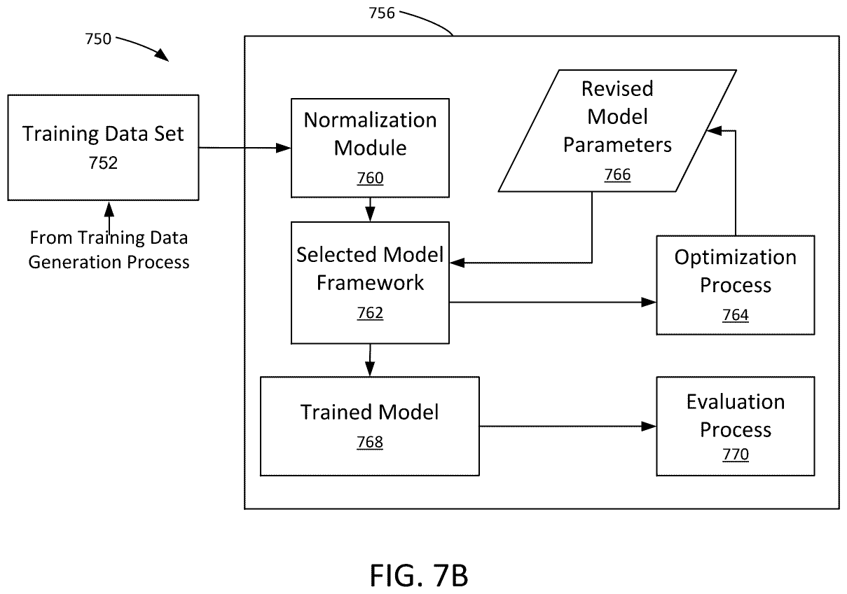

In some embodiments, a model endpoint can include and/or implement one or more trained models, such as a deep learning or machine learning/large language models. In some embodiments, one or more trained models can be generated using an iterative training process based on a training dataset. FIG. 7A illustrates a method 700 for generating a trained model, such as a trained artificial intelligence aided data entry form filler model, in accordance with some embodiments. FIG. 7B is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data. For example, in some embodiments, a set of filled forms that are labeled as validated and final is provided for use in training a model.

At optional step 704, the received training dataset 752 is processed and/or normalized by a normalization module 760. For example, in some embodiments, the training dataset 752 can be augmented by imputing or estimating missing values of one or more features associated with free text user input. In some embodiments, processing of the received training dataset 752 includes outlier detection to remove data likely to skew training. In some embodiments, processing of the received training dataset 752 includes removing features that have limited value with respect to training of the model endpoints.

At step 706, an iterative training process is executed to train a selected model framework 762. The selected model framework 762 can include an untrained (e.g., base) machine learning model, such as deep learning or large or small language models, and/or a partially or previously trained model (e.g., a prior version of a trained model). The training process iteratively adjusts parameters (e.g., hyperparameters) of the selected model framework 762 to minimize a cost value (e.g., an output of a cost function) for the selected model framework 762. In some embodiments, the cost value is related to a need for further manual data entry.

The training process is an iterative process that generates set of revised model parameters 766 during each iteration. The set of revised model parameters 766 can be generated by applying an optimization process 764 to the cost function of the selected model framework 762. The optimization process 764 can reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, such as a trained small language model, is output and provided for use in a method of suggesting answers for interactive digital forms, such as the method discussed above with respect to FIGS. 3, 4, and 5. At optional step 712, a trained model 768 can be evaluated by an evaluation process 770. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

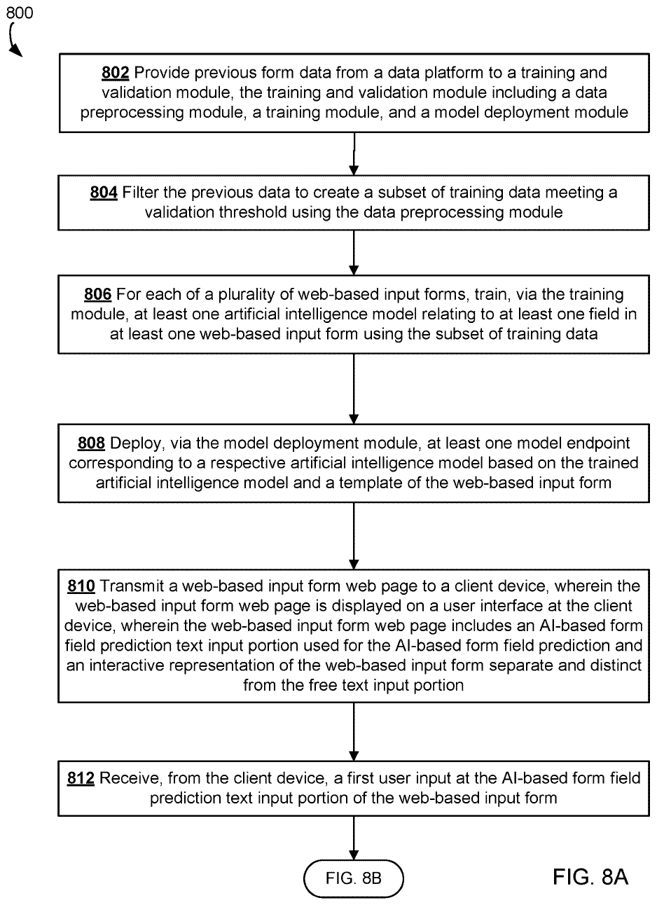

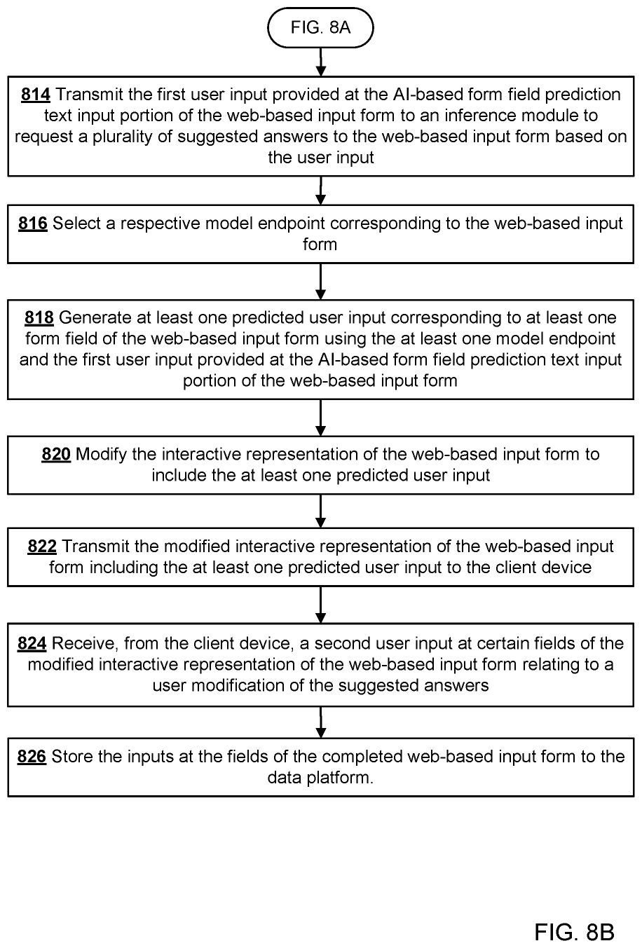

FIGS. 8A-8B are flowcharts illustrating a method, in accordance with some embodiments. The method includes:
Step 802: Provide previous form data from a data platform to a training and validation module, the training and validation module including a data preprocessing module, a training module, and a model deployment module;
Step 804: Filter the previous data to create a subset of training data meeting a validation threshold using the data preprocessing module;
Step 806: For each of a plurality of web-based input forms, train, via the training module, at least one artificial intelligence model relating to at least one field in at least one web-based input form using the subset of training data;
Step 808: Deploy, via the model deployment module, at least one model endpoint corresponding to a respective artificial intelligence model based on the trained artificial intelligence model and a template of the web-based input form;
Step 810: Transmit a web-based input form web page to a client device, wherein the web-based input form web page is displayed on a user interface at the client device, wherein the web-based input form web page includes an AI-based form field prediction text input portion used for the AI-based form field prediction and an interactive representation of the web-based input form separate and distinct from the free text input portion;
Step 812: Receive, from the client device, a first user input at the AI-based form field prediction text input portion of the web-based input form;
Step 814: Transmit the first user input provided at the AI-based form field prediction text input portion of the web-based input form to an inference module to request a plurality of suggested answers to the web-based input form based on the user input;
Step 816: Select a respective model endpoint corresponding to the web-based input form;
Step 818: Generate at least one predicted user input corresponding to at least one form field of the web-based input form using the at least one model endpoint and the first user input provided at the AI-based form field prediction text input portion of the web-based input form;
Step 820: Modify the interactive representation of the web-based input form to include the at least one predicted user input;
Step 822: Transmit the modified interactive representation of the web-based input form including the at least one predicted user input to the client device;
Step 824: Receive, from the client device, a second user input at certain fields of the modified interactive representation of the web-based input form relating to a user modification of the suggested answers;
Step 826: Store the inputs at the fields of the completed web-based input form to the data platform.

Although the subject matter has been described in terms of exemplary embodiments, it is not limited thereto. Rather, the appended claims should be construed broadly, to include other variants and embodiments, which may be made by those skilled in the art.

What is claimed is:

1. A system for artificial intelligence (AI)-based form field prediction of web-based input forms, comprising:
a processor; and
a non-transitory memory storing instructions, that when executed, cause the processor to:
provide previous form data from a data platform to a training and validation module, the training and validation module including a data preprocessing module, a training module, and a model deployment module;
filter the previous data to create a subset of training data meeting a validation threshold using the data preprocessing module;
for each of a plurality of web-based input forms, train, via the training module, at least one model relating to at least one field in at least one web-based input form using the subset of training data;
deploy, via the model deployment module, at least one model endpoint corresponding to a respective model based on the model and a template of the web-based input form;
transmit a web-based input form to a client device, wherein the web-based input form is displayed on a user interface at the client device, wherein the web-based input form includes an AI-based form field prediction text input portion used for AI-based form field prediction and an interactive representation of the web-based input form separate and distinct from the AI-based form field prediction text input portion;
receive, from the client device, a first user input at the AI-based form field prediction text input portion of the web-based input form;
transmit the first user input provided at the AI-based form field prediction text input portion of the web-based input form to an inference module to obtain a plurality of suggested answers to the web-based input form based on the user input;
select a respective model endpoint corresponding to the web-based input form;
generate at least one predicted user input corresponding to at least one form field of the web-based input form using the at least one model endpoint and the first user input provided at the AI-based form field prediction text input portion of the web-based input form;
modify the interactive representation of the web-based input form to include the at least one predicted user input;
transmit the modified interactive representation of the web-based input form including the at least one predicted user input to the client device;
receive, from the client device, a second user input at certain fields of the modified interactive representation of the web-based input form relating to a user modification of the suggested answers; and
store the inputs at the fields of the web-based input form to the data platform.

2. The system of claim 1, wherein generating at least one predicted user input corresponding to at least one form field of the web-based input form includes:
detecting personal information within the first user input, and
generating at least one predicted user input corresponding to at least one form field of the web-based input form using the detected personal information.

3. The system of claim 1, wherein the processor further reads the instructions to translate the first user input from a first natural language to a second natural language, wherein the first natural language is a different natural language from the second natural language, and wherein the second natural language is the same as a reference natural language that is used in the previous data provided to the training and validation module to train the at least one model.

4. The system of claim 1, wherein the processor further reads the instructions to detect an acronym in the first user input, and to replace the acronym with an expanded form of the acronym prior to parsing the first user input with the at least one model endpoint.

5. The system of claim 1, wherein the processor further reads the instructions to calculate a reliability probability for one of the plurality of suggested answers, and to refrain from modifying the interactive representation of the web-based input form to include a predicted user input if the probability is below a reliability threshold.

6. The system of claim 1, wherein selecting a respective model endpoint corresponding to the web-based input form includes deploying at least two model endpoints based on at least two trained models corresponding to one of the web-based input forms, and selecting one of the respective model endpoints having the highest reliability probability.

7. The system of claim 6, wherein one of the at least two models is a machine learning model, and wherein one of the at least two models is a deep learning model.

8. A computer-implemented method, comprising:
providing previous form data from a data platform to a training and validation module, the training and validation module including a data preprocessing module, a training module, and a model deployment module;
filtering the previous data to create a subset of training data meeting a validation threshold using the data preprocessing module;
for each of a plurality of web-based input forms, training, via the training module, at least one model relating to at least one field in at least one web-based input form using the subset of training data;
deploying, via the model deployment module, at least one model endpoint corresponding to a respective model based on the model and a template of the web-based input form;
transmitting a web-based input form to a client device, wherein the web-based input form is displayed on a user interface at the client device, wherein the web-based input form includes an AI-based form field prediction text input portion used for the AI-based form field prediction and an interactive representation of the web-based input form separate and distinct from the AI-based form field prediction text input portion;
receiving, from the client device, a first user input at the AI-based form field prediction text input portion of the web-based input form;
transmitting the first user input provided at the AI-based form field prediction text input portion of the web-based input form to an inference module to obtain a plurality of suggested answers to the web-based input form based on the user input;
selecting a respective model endpoint corresponding to the web-based input form;
generating at least one predicted user input corresponding to at least one form field of the web-based input form using the at least one model endpoint and the first user input provided at the AI-based form field prediction text input portion of the web-based input form;
modifying the interactive representation of the web-based input form to include the at least one predicted user input;
transmitting the modified interactive representation of the web-based input form including the at least one predicted user input to the client device;
receiving, from the client device, a second user input at certain fields of the modified interactive representation of the web-based input form relating to a user modification of the suggested answers; and
storing the inputs at the fields of the web-based input form to the data platform.

9. The method of claim 8, wherein generating at least one predicted user input corresponding to at least one form field of the web-based input form includes:
detecting personal information within the first user input, and
generating at least one predicted user input corresponding to at least one form field of the web-based input form using the detected personal information.

10. The method of claim 8, further comprising translating the first user input from a first natural language to a second natural language, wherein the first natural language is a different natural language from the second natural language, and wherein the second natural language is the same as a reference natural language that is used in the previous data provided to the training and validation module to train the at least one model.

11. The method of claim 8, further comprising detecting an acronym in the first user input, and to replace the acronym with an expanded form of the acronym prior to parsing the first user input with the at least one model endpoint.

12. The method of claim 8, further comprising calculating a reliability probability for one of the plurality of suggested answers, and to refrain from modifying the interactive representation of the web-based input form to include a predicted user input if the probability is below a reliability threshold.

13. The method of claim 8, wherein selecting a respective model endpoint corresponding to the web-based input form includes deploying at least two model endpoints based on at least two trained models corresponding to one of the web-based input forms, and selecting one of the respective model endpoints having the highest reliability probability.

14. The method of claim 13, wherein one of the at least two models is a machine learning model, and wherein one of the at least two models is a deep learning model.

15. A non-transitory computer readable medium having instructions stored thereon, wherein the instructions, when executed by at least one processor, cause at least one device to perform operations comprising:
providing previous form data from a data platform to a training and validation module, the training and validation module including a data preprocessing module, a training module, and a model deployment module;
filtering the previous data to create a subset of training data meeting a validation threshold using the data preprocessing module;
for each of a plurality of web-based input forms training, via the training module, at least one model relating to at least one field in at least one web-based input form using the subset of training data;
deploying, via the model deployment module, at least one model endpoint corresponding to a respective model based on the model and a template of the web-based input form;
transmitting a web-based input form to a client device, wherein the web-based input form is displayed on a user interface at the client device, wherein the web-based input form includes an AI-based form field prediction text input portion used for the AI-based form field prediction and an interactive representation of the web-based input form separate and distinct from the AI-based form field prediction input portion;
receiving, from the client device, a first user input at the AI-based form field prediction text input portion of the web-based input form;
transmitting the first user input provided at the AI-based form field prediction text input portion of the web-based input form to an inference module to request a plurality of suggested answers to the web-based input form based on the user input;
selecting a respective model endpoint corresponding to the web-based input form;
generating at least one predicted user input corresponding to at least one form field of the web-based input form using the at least one model endpoint and the first user input provided at the AI-based form field prediction text input portion of the web-based input form;
modifying the interactive representation of the web-based input form to include the at least one predicted user input;
transmitting the modified interactive representation of the web-based input form including the at least one predicted user input to the client device;
receiving, from the client device, a second user input at certain fields of the modified interactive representation of the web-based input form relating to a user modification of the suggested answers; and
storing the inputs at the fields of the web-based input form to the data platform.

16. The medium of claim 15, wherein generating at least one predicted user input corresponding to at least one form field of the web-based input form includes:
detecting personal information within the first user input, and
generating at least one predicted user input corresponding to at least one form field of the web-based input form using the detected personal information.

17. The medium of claim 15, wherein the instructions, when executed by at least one processor, cause at least one device to further perform operations comprising: translating the first user input from a first natural language to a second natural language, wherein the first natural language is a different natural language from the second natural language, and wherein the second natural language is the same as a reference natural language that is used in the previous data provided to the training and validation module to train the at least one model.

18. The medium of claim 15, wherein the instructions, when executed by at least one processor, cause at least one device to further perform operations comprising: detecting an acronym in the first user input, and to replace the acronym with an expanded form of the acronym prior to parsing the first user input with the at least one model endpoint.

19. The medium of claim 15, wherein the instructions, when executed by at least one processor, cause at least one device to further perform operations comprising: calculating a reliability probability for one of the plurality of suggested answers, and to refrain from modifying the interactive representation of the web-based input form to include a predicted user input if the probability is below a reliability threshold.

20. The medium of claim 15, wherein selecting a respective model endpoint corresponding to the web-based input form includes deploying at least two model endpoints based on at least two trained models corresponding to one of the web-based input forms, and selecting one of the respective model endpoints having the highest reliability probability.

21. The medium of claim 20, wherein one of the at least two models is a machine learning model, and wherein one of the at least two models is a deep learning model.
